(19) United States
(12) Patent Application Publication
(10) Pub. No.: US 2003/0233632 A1
(43) Pub. Date: Dec. 18, 2003

(54) Automatically generated client application source code using database table definitions

(75) Inventors: Michael L. Aigen, Vestal, NY (US); Yekaterina Y. Shkarlet, Ithaca, NY (US)

Correspondence Address: TAROLLI, SUNDHEIM, COVELL & TUMMINO L.L.P., 526 SUPERIOR AVENUE, SUITE 1111, CLEVEVLAND, OH, 44114, US

(73) Assignee: Lockheed Martin Corporation

(21) Appl. No.: 10/170,836

(22) Filed: Jun. 12, 2002

(51) Int. Cl. G06F 9/44

(52) U.S. Cl. 717/106

(57) ABSTRACT

A computer product for generating application source code on a client computer for querying database tables on a server computer includes a portion for obtaining database structure information for the database tables from database table definition files on the server computer. The computer product also includes a portion operative to construct database queries using the database structure information. The database queries are constructed in a database query language required to query information from the database tables on the server computer. The computer product further includes a portion for constructing application source code commands for executing the database queries. The application source code commands are constructed in a programming language of the client application.

### FIELD OF THE INVENTION

The present invention relates to developing client applications in a client-server architecture. More particularly, the present invention relates to generating client application source code automatically using database table definitions.

### BACKGROUND OF THE INVENTION

In a client-server architecture, a client computer communicates with a server computer via a network. The network may be a local area network, wide area network, Internet, etc. The performance of any particular client-server architecture typically depends on the processing limitations of the server and the network. Factors such as the number of clients accessing the server, the processing speed, data archive/retrieval speed, storage capacity, communication speed of the server, and the speed/bandwidth, etc., of the network all may have an effect on the ability to retrieve, process, and store data in the client-server architecture.

In the field of information systems and data processing in a client-server architecture, it is often necessary to develop client-based software applications that read from or write to tables of existing server-based databases. These databases often include large amounts of data that is accessed by a variety of client applications. Such databases are sometimes referred to as “legacy” databases. This is because these databases are so large and widely used that they cannot feasibly be replaced without necessitating widespread updates of the many client applications that access the data stored therein. These legacy databases thus extend through many generations of client/server applications.

In such a client-server architecture, the client applications send messages in the form of queries to the server in order to read from or write to the database tables stored on the server. The performance characteristics of the client-server system affects its capacity to handle volumes of query traffic. Conversely, the volume of query traffic from the client to the server may affect the performance of the client-server system.

When developing client application software, the process of developing queries to access database tables on a server can be burdensome and may require extensive manual input which is both time-consuming and error-prone. The software developer must access the database table definitions to determine how the data in each particular table is structured. The developer must also determine how the data in different tables relates to each other. The developer then uses this information to develop queries in the client application that read from and write to the tables on the server.

Also, in a client-server system, multiple application developers and other personnel may have access to the same server-based databases. These personnel may also have the ability to update or modify data contained in the database tables and/or the structure of the database tables. Therefore, the application developer must also face the possibility that the database table definitions may be updated by other personnel. This may occur, for example, when a field is added to or deleted from a table. In this situation, the client application must also be updated to reflect the updated table definition and maintain synchronization between the tables and the application. This provides additional burdens on the application developer.

Furthermore, a server typically operates on a database management system (“DBMS”) software platform which requires that database queries be performed in a particular database query language, such as Structured Query Language (“SQL”). The client application, however, may be written in a programming language, such as Java using the Java Database Connectivity (“JDBC”) application program interface (“API”). As a result, the software developer must be proficient in the use of the database connectivity API as well as the database query language in order to develop the client application. This may further burden a developer who is unfamiliar or who lacks proficiency in the particular query language required by the DBMS.

### SUMMARY OF THE INVENTION

The present invention is directed to automatically generating client-based application source code for reading from and writing to database tables stored on a server. In object oriented development, these source components are referred to as Data Access Objects (“DAO”). According to the present invention, a client-based database query determination application is operative to access server-based database tables via a network to obtain user-selected database table definitions. Using the information provided in the database table definitions, the database query determination application automatically generates application DAO source code for querying the database tables using the proper syntax required by the database query language. The application DAO source code generated by the query determination application may then be incorporated into the client application source code. The client application, when compiled and executed, will thus query the database tables using the proper database query syntax.

In an illustrated embodiment, a Java client application uses JDBC API to access database tables on a server operating on a DBMS that requires the use of SQL. A client-based Java database SQL query determination application, referred to as a “SQUIRREL” application, is operative to access server-based database tables via the network. Reading database table definitions from the server, the SQUIRREL application automatically generates Java DAO classes for querying the database tables using SQL. These automatically generated Java DAO classes may then be incorporated in the client application source code. When compiled and executed, the client application will thus be operative to query the database tables using the proper SQL syntax. The SQUIRREL application of the present invention thus eliminates the need for the application developer to develop code for executing the SQL queries manually.

The present invention is also directed to a database batch client application and a database batch server application. The database batch client application is a client-based application for gathering a batch of multiple database queries as directed by a client application. The database batch client application sends the batch of queries to the server-based database batch server application. The database batch server application receives the batch of queries and executes the queries on the appropriate database tables. The database batch server sends any requested results to the database batch client application which, in turn, provides the results to the client application.

The illustrated embodiment includes a Java database batch client (“DB batch client”) and a Java database batch servlet (“DB batch servlet”). The DB batch client is a client-based Java class for gathering a batch of database queries as directed by a Java client application. The DB batch client sends a Java Vector of the database queries to the server via the network. The DB batch servlet is a server-based Java class for receiving the batch, i.e., the Java Vector, from the DB batch client and executing the queries contained in the batch. The DB batch servlet receives the batch and executes the queries in the batch on the appropriate server based database tables. The DB batch servlet sends results of the queries to the DB batch client which, in turn, provides the results to the client application.

In the illustrated embodiment, the batch of queries supplied to the DB batch client by the client application includes the Java DAO classes for querying the database tables using SQL as determined automatically by the SQUIRREL application. The DB batch servlet, upon receiving the batch of Java DAO classes, executes the queries using SQL and returns any requested results to the client application via the DB batch client.

According to one aspect of the present invention, a computer product is operative to generate application source code on a client computer for querying database tables on a server computer. The computer product includes a portion for obtaining database structure information for the database tables from database table definition files on the server computer. The computer product also includes a portion operative to construct database queries using the database structure information. The database queries are constructed in a database query language required to query information from the database tables on the server computer. The computer product further includes a portion for constructing application source code commands for executing the database queries. The application source code commands are constructed in a programming language of the client application.

According to another aspect of the present invention, a computer implemented method generates application source code on a client computer for querying database tables on a server computer. The method includes the step of obtaining database structure information for the database tables from database table definition files on the server computer. The method also includes the step of constructing database queries using the database structure information. The database queries are constructed in a database query language required to query information from the database tables on the server computer. The method further includes the step of constructing application source code commands for executing the database queries. The application source code commands are constructed in a programming language of the client application.

According to a further aspect of the present invention, a computer product is implementable on a system including a client computer and a server computer operatively connected to each other by a network. The computer product includes a client-based portion resident to the client computer. The client-based portion is operative to gather a batch including a plurality of database queries and send the batch to the server computer via the network. The computer product also includes a server-based portion resident to the server computer. The server-based portion is operative to receive the batch from the client-based portion and execute the database queries in the batch on a database resident to the server computer.

### BRIEF DESCRIPTION OF THE DRAWINGS

The foregoing and other features and advantages of the present invention will become apparent to those skilled in the art to which the present invention relates upon reading the following description with reference to the accompanying drawings, wherein:

FIG. 1 is a schematic representation of a client-server system upon which the present invention may be implemented, according to an illustrated embodiment of the present invention;

FIG. 2 is a block diagram illustrating the functional elements of the present invention, according to the illustrated embodiment of the present invention;

FIG. 3 is a data flow diagram illustrating a process for automatically generating application source code using database table definitions, according to the illustrated embodiment of the present invention; and

FIG. 4 is a data flow diagram illustrating a process for using the automatically generated application source code, according to the illustrated embodiment of the present invention.

### DESCRIPTION OF AN ILLUSTRATED EMBODIMENT

The present invention relates to developing client applications in a client-server architecture wherein a client computer communicates with a server computer via a network. In particular, the present invention relates to generating client application source code automatically using database table definitions.

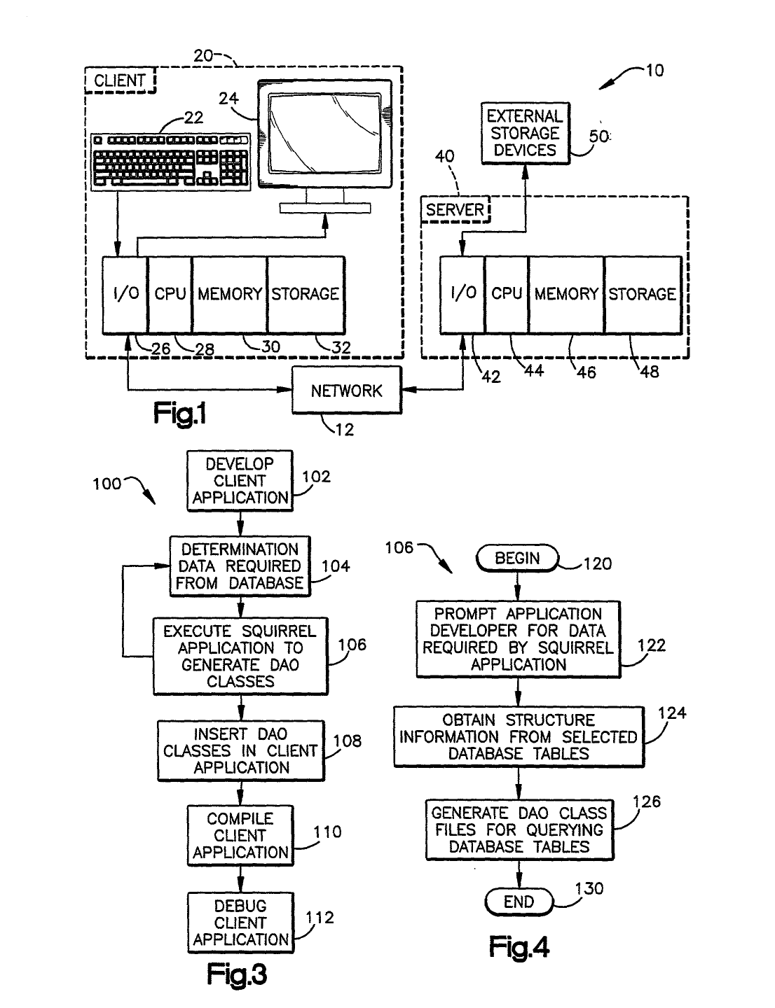

An example of a client-server architecture in which the present invention may be implemented is illustrated in the system of FIG. 1. The system includes computer hardware and software that together support the development and execution of the software applications described herein. Those skilled in the art will be appreciated that there are a variety of alternative hardware/software configurations which are capable of supporting the application development and execution described herein. The system illustrated in FIG. 1 is for purposes of example only and should not be interpreted to preclude or otherwise limit the use of these various alternative hardware/software configurations.

Referring to FIG. 1, a system 10 includes a client computer, hereinafter referred to as a client 20, that communicates with a server computer, hereinafter referred to as a server 40, via a network 12. The client 20 and server 40 may comprise any known computing platform suitable for use in a client-server architecture. Also, the system 10 is not limited to an architecture including a single client 20 and a single server 40. It will be appreciated that the system may include any number of clients 20 and/or servers 40.

The network 12 may comprise any known network configuration suitable for providing communications between the client 20 and the server 40. For example, the network 12 may include a local area network (LAN), wide area network (WAN), Internet, etc., or a combination thereof.

The client 20 includes user interface hardware, such as a keyboard 22 and a monitor 24. The client 20 may also include other user interface hardware (not shown), such as a mouse, trackball, etc. The client 20 also includes input/output (I/O) hardware 26, a central processing unit (CPU) 28, memory devices 30 (e.g., RAM) and storage devices 32 (e.g., hard drive, CD-ROM, tape, etc.). The I/O hardware 26, CPU 28, memory devices 30, and storage devices 32 are operatively connected to each other by known means, such as a system bus. The keyboard 22 and monitor 24 are operatively connected to the CPU 28, memory devices 30, and storage devices 32 via the I/O hardware 26.

The server 40 includes I/O hardware 42, a CPU 44, memory devices 46, and storage devices 48. Because servers typically handle a large amount of data, the server 40 may also include additional external storage devices 50 in the form of hard drives, CD-ROM, tape, etc. The I/O hardware 42, CPU 44, memory devices 46, and storage devices 48 are operatively connected to each other by known means, such as a system bus. The external storage devices 50 are operatively connected to the server 40 via a hardware connection, such as a SCSI interface, or via a network connection, such as a LAN.

The present invention relates to the development of software applications for installation and use on the client 20, referred to herein as “client applications.” More particularly, the present invention relates to developing client applications that access data stored in database(s) located on the server 40. Those skilled in the art, however, will appreciate that the present invention could also apply to the development of software applications for installation on the server 40 or software applications for use on a single stand alone computer.

In this description of an illustrated embodiment, the server 40 operates on a database management system (“DBMS”) software platform which requires that database queries be performed in Structured Query Language (“SQL”). The client application is written in a Java programming language and utilizes the Java Database Connectivity (“JDBC”) application program interface (“API”). It will be appreciated, however, that the server 40 may operate on any suitable DBMS software platform, which may require the use of other known query languages. Similarly, the client application may be written in any suitable programming language and may use any suitable database connectivity API.

In the illustrated embodiment, the developer must insert SQL queries in the Java client application source code in order to read data from and/or write data to the server database. This may be a time-consuming and error-prone process, depending on a variety of factors such as the developer's knowledge in using SQL, the developer's familiarity with the data being accessed, the frequency at which the database tables are updated by other users, etc. The present invention helps alleviate these difficulties by automatically generating source code for accessing the database tables. This automatically generated source code can be inserted into the client application source code such that the client application, when compiled, may access the database tables. In the illustrated embodiment, Java Data Access Object “DAO”) source code for executing SQL queries is generated automatically based on database table definitions stored on the server 40.

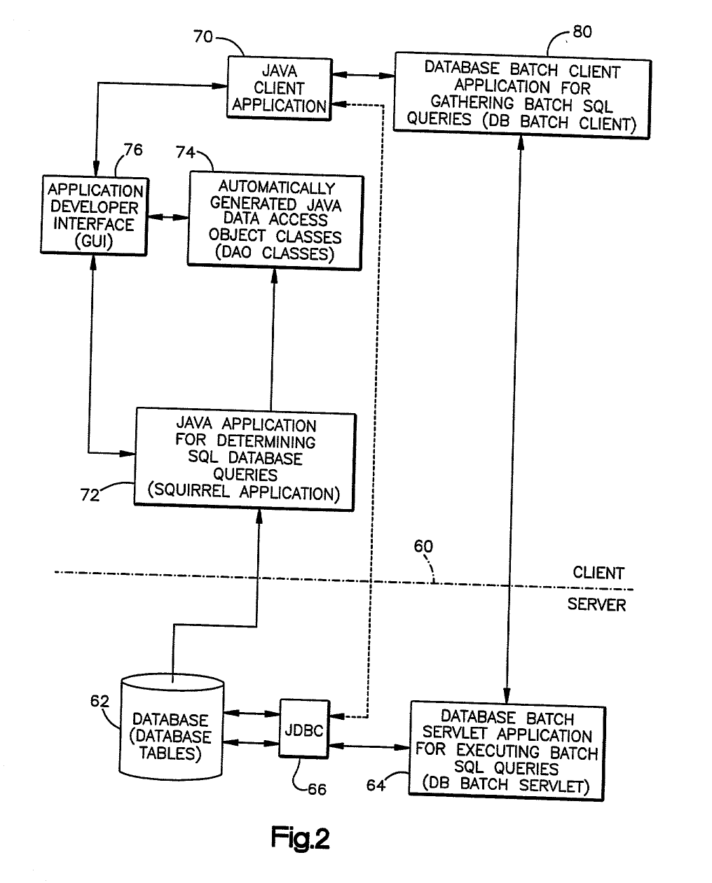

FIG. 2 illustrates the functional elements of the present invention as implemented in the illustrated embodiment of the invention. Referring to FIGS. 1 and 2, a dot-dashed line indicated at 60 separates functions performed on the “client side” of the system 10, i.e., on client computer 20, from functions performed on the “server side” of the system, i.e., on the server computer 40. The client side is indicated above the dashed line 60 and the server side is indicated below the line. Communication between the client side and the server side is established via the network 12 (see FIG. 1).

The server side includes a database 62 which may reside on the storage device 48 of the server computer 40 or on the external storage devices 50. The database 62 may comprise any number of databases, each of which may include any number of database tables. The database 62 also includes database table definitions which define the tables of each database. These database table definitions include information such as table names, field names, field data types, field sizes, key fields, etc.

The server side also includes a database batch servlet application, referred to hereinafter as a DB batch servlet 64. In the illustrated embodiment, the DB batch servlet 64 is a Java application residing on the server computer 40. The DB batch servlet 64 comprises a computer product (i.e., program) operative to execute SQL queries that read data from and write data to the database 62 and to receive the results of the queries. The DB batch servlet 64 accesses the database 62 via a Java Database Connectivity Application Program Interface (“JDBC API”), indicated at 66.

The client side includes the Java client application 70. The client side also includes a Java application for determining SQL database queries 72, hereinafter referred to as a “SQUIRREL” application. The SQUIRREL application 72 comprises a computer product (i.e., program) operative to read database table definitions from the database 62 to determine SQL queries for accessing the tables in the database. This will be discussed below in further detail. The SQUIRREL application 72 is operative to generate Java DAO classes automatically for querying the database tables using SQL, indicated at 74 and referred to hereinafter as “DAO classes”.

The developer accesses the client application 70 via an application developer interface, indicated at 76, to develop (i.e., write, compile, debug, etc.) the client application. This is sometimes referred to as a graphical user interface (“GUI”). The developer interface 76 comprises the interface devices (keyboard 22, monitor 24, etc.) of the client computer 20 (see FIG. 1). The developer may also access the SQUIRREL application 72 to execute the application via the interface 76. The developer further may access the DAO classes 74 generated by the SQUIRREL application 72 via the interface 76 to insert the DAO classes in the client application 70 (e.g., via cut and paste).

The client side includes a database batch client application, referred to hereinafter as a DB batch client 80. In the illustrated embodiment, the DB batch client 80 is a Java application residing on the client computer 20. The DB batch client 80 could, however, be written in any suitable programming language. The DB batch client 80 comprises a computer product (i.e., program) operative to receive one or more SQL queries from the client application 70 in a batch.

In the illustrated embodiment, the batch comprises a Java Vector. The DB batch client 80 is operatively connected to the DB batch servlet 64 to provide the batch of SQL queries to the servlet. The DB batch servlet 64 is operative to execute the batch of SQL queries on the database 62 and receive results from the queries via the JDBC API 66. The DB batch servlet 64 is further operative to provide the results of the queries to the DB batch client 80. The DB batch client 80 is further operative to provide the query results to the client application 70.

The DAO classes 74 may also be implemented in the client application 70 to query the database 62 independent from the DB batch client 80 and DB batch servlet 64. This is indicated by the dashed line in FIG. 2. As illustrated in FIG. 2, the client application 70 queries the database 62 directly via the JDBC API 66.

A high level flow diagram of a process 100 in which the present invention is implemented is illustrated in FIG. 3. The process 100 of FIG. 3 is best understood when viewed together with the functional block diagram of FIG. 2. In this description of an illustrated embodiment, the use of the word “step” is used to describe functions performed during the process 100.

The processes described in this description of an illustrated embodiment are meant to illustrate the steps or functions performed by the present invention. Those skilled in the art will appreciate that application development may be a repetitive process wherein source code is written, updated and modified over several iterations. Accordingly, the process 100 of FIG. 3 and the other processes described herein are not necessarily meant to limit or dictate the sequence or frequency in which steps in the respective processes of the present invention are performed. Depending upon particular situational conditions in which the processes are being performed, certain steps may be performed with a greater frequency than others and certain steps may even be skipped or omitted.

The client application is developed at step 102. During this development, it may be determined that information stored on data tables of the database 62 needs to be accessed. Thus, next, a determination is made as to which data (e.g., data tables) is required from the database 62. Those skilled in the art will appreciate that the application development of step 102 and the determination of step 104 may not occur sequentially and may occur simultaneously or in a series multiple steps going back and forth between each other. Once the data required from the database 62 is determined, the process 100 proceeds to step 106.

At step 106, the application developer executes the SQUIRREL application 72, which generates the DAO classes 74 required to obtain the required data from the database 62. As indicated by the arrow leading back to step 104 from step 106, the information generated by the SQUIRREL application 72 may be used to assist in determining the data required from the database 62 at step 104. At step 108, the developer inserts the DAO classes 74 in the client application 70 so that data may be read from or written to the database 62. At step 110, the client application is compiled and then debugged at step 112. As stated above, the steps of the process 100 may be repeated, in any sequence or frequency, until development of the client application is completed. Accordingly, the developer may develop a client application 70 that reads data from or writes data to the database 62 without having knowledge of the SQL language and without having to undergo the burdens of writing and debugging any SQL code.

Advantageously, the use of the present invention also allows for updating the client application 70 in a quick and efficient manner. For example, if the database 62 is subsequently updated in a manner such that the previously generated DAO classes 74 are rendered incorrect or inoperable, the SQUIRREL application 72 can simply be re-executed to generate updated DAO classes. The client application 70 can thus be updated to include the updated DAO classes 74 so that the modifications to the database 62 are taken into account by the client application.

Those skilled in the art will appreciate that the process involved in executing the SQUIRREL application of step 106 in FIG. 3 may be accomplished in various alternative manners. An illustration of the process for executing the SQUIRREL application 72 of step 106 is illustrated in FIG. 4, according to the illustrated embodiment of the present invention. The process of step 106 of FIG. 4 is best understood when viewed together with the functional block diagram of FIG. 2.

The SQUIRREL application 72 is operative to perform a variety of functions to provide the SQL queries in the generated DAO classes 74 for reading data from and/or writing data to selected tables of the database 62. In the illustrated embodiment, the SQUIRREL application 72 is a Java class that may include a variety of methods and/or may inherit methods from other classes. Thus, in this description of an illustrated embodiment, when reference is made to the SQUIRREL application 72 including methods for performing a particular function, it is meant that the method is included in the SQUIRREL application itself or in a Java class from which the SQUIRREL application inherits.

At step 122, the application developer is prompted for data required by the SQUIRREL application 72. The application developer provides the data via the application developer interface 76. The SQUIRREL application 72 prompts the developer for information such as the names of the database tables for which the DAO classes 74 are to be generated, the location on the network where the tables of the database 62 are located, and the location on the client where the DAO classes 74 are to be generated.

The SQUIRREL application 72 prompts the developer for input via operator input devices such as the keyboard and/or mouse. The developer interface portion of the SQUIRREL application 72 may thus take the form of a graphical user interface (“GUI”) that is commonly referred to in the art of computer programming as an application “wizard.” Application wizards are used to prompt the user (in this case the application developer) to step through the actions required to execute the application. The SQUIRREL application 72 may thus include a wizard that steps the application developer through a visual or menu-driven sequence of steps for querying the information required by the SQUIRREL application. Once the required information has been provided to the SQUIRREL application 72, the process of step 106 proceeds to step 124.

At step 124, the SQUIRREL application 72 obtains structure information for the tables of the database 62 selected by the application developer at step 122. In order to achieve this result, the SQUIRREL application 72 includes a method for accessing the “metadata” in table definitions. The metadata includes database structure information such as field names, field data types, fields lengths, key fields, etc. for the fields in the selected table of the database 62. The SQUIRREL application 72 is operative to retrieve the structure information for the selected table for use in generating the DAO classes 74.

The SQUIRREL application 72 may also provide the structure information for the selected database table in the form of a table overview in the generated DAO classes 74 which the application developer may use as a reference in writing the client application 70. The table overview may include table statistics, such as the size of the table, number of fields, number of records, etc. The table overview may also include information pertaining to the various fields in the table, such as field names, field data types, field sizes, key fields, etc.

Once the structure information for the selected database tables is determined at step 124, the process of step 106 proceeds to step 126.

At step 126, the SQUIRREL application 72 generates the DAO classes 74 for querying the selected database tables. The SQUIRREL application 72 generates two main types of DAO classes for querying the selected database tables. The SQUIRREL application 72 generates a Table encapsulation class for querying the entire selected database table, and the SQUIRREL application generates a Row encapsulation class for querying a single row or multiple rows of data from the selected database table. By encapsulation, it is meant that information pertaining to the data included in each field of the row as well as the structure of each field in the row may be read.

In this description, when the words Table and Row are capitalized, reference is being made to the Table and Row Java DAO classes. This is done to help distinguish the Table and Row DAO classes from the actual tables and rows in the database. This also follows common Java application programming practice wherein class names are capitalized.

The Table encapsulation class encapsulates the entire selected database table. The Table encapsulation class includes the appropriate SQL queries for selecting all of the fields for all of the rows of the table. The Table encapsulation class may thus be incorporated in the client application to read the entire selected database table from the server and construct an instance of the Table on the client. The data from the selected database table may thus be accessed and manipulated locally at the client.

The Row encapsulation class include a variety of Java methods for executing the appropriate SQL queries for querying a single row or multiple rows from the selected database table. The Java methods included in the Row encapsulation class are described below.

The Row encapsulation class includes a Java method for inserting a row in the selected database table. This Row insertion method can be invoked in the client application 70 by the application developer. The client application 70, when compiled, will thus be able to insert a row in the selected database table using the SQL statement included in the Row insertion method.

The Row encapsulation class also includes a Java method for reading a single row or multiple rows from the selected database table. The row(s) read may be selected based on a key field or on a conditional statement, such as a “where” or “for” statement. This Row reading method can be invoked in the client application 70 by the application developer. The client application 70, when compiled, will thus be able to read a row in the selected database table using the SQL statement included in the Row reading method. It will be appreciated that reading a single row of data from the selected database table may also be used to construct an empty Table on the client having a structure identical to the selected database table.

The Row encapsulation class also includes a Java method for updating a single row or multiple rows in the selected database table. The row(s) may be updated based on a key field or on a conditional statement, such as a “where” or “for” statement. This Row updating method can be invoked in the client application 70 by the application developer. The client application 70, when compiled, will thus be able to update a row in the selected database table using the SQL statement included in the Row updating method.

The Row encapsulation class further includes a Java method for deleting a single row or multiple rows from the selected database table. The row(s) may be deleted based on a key field or on a conditional statement, such as a “where” or “for” statement. This Row deletion method can be invoked in the client application 70 by the application developer. The client application 70, when compiled, will thus be able to delete a row in the selected database table using the SQL statement included in the Row deletion method.

The DAO classes may also include a variety of other Java methods for performing desired functions such as setting the name of the selected database table, adding, deleting, or modifying rows in the selected database table, etc. These methods can be invoked in the client application 70 by the application developer. The client application 70, when compiled, will thus be operable to perform the various operations (set table name, add row(s), delete row(s), modify field(s), etc.) using the SQL statement included in the methods.

Once the DAO classes 74 are generated, the process of step 106 proceeds to step 130 where the process ends.

Those skilled in the art will appreciate that the SQUIRREL application 72 may be adapted to execute in a variety of manners. For example, the SQUIRREL application 72 may be operative to generate DAO classes for selected database tables individually (e.g., one at a time) or simultaneously. The SQUIRREL application 72 may also be adapted to provide a single file including both the Row and Table encapsulation classes, or individual files for the Row and Table encapsulation classes. The SQUIRREL application 72 may further be adapted to prompt the user to select whether Table encapsulation classes, Row encapsulation classes, or both are desired and generate the appropriate classes accordingly.

The DAO classes 74 generated by the SQUIRREL application 72 thus provide the application developer with the source code required to query the selected database tables using the required database query language. This allows the developer to incorporate the database queries without having to develop (write, debug, compile, etc.) the database queries on his/her own. This also allows a developer that may not be proficient in the required database query language to develop the client application 70 in an effective and efficient manner. The client application 70 may thus read data from the selected database tables, manipulate the data locally at the client, and update the tables on the server.

Those skilled in the art will appreciate that the volume of communications on a network, sometimes referred to as “network traffic,” may affect the performance characteristics of the network. In the context of the system 10 of FIG. 1, traffic on the network 12 may be affected by the volume of communication between the client 20 and server 40. Thus, it will be appreciated that it may be desirable to attempt to reduce or minimize the communications between the client and server 40. According to the present invention, the DB batch client 80 and the DB batch servlet 64 help to achieve these goals.

Referring to FIG. 2, the client application 70 may be operative to perform a large number of queries to server based database tables that, performed individually, would cause high volume network traffic. The DB batch client 80 and the DB batch servlet 64 help reduce the volume of network traffic caused be execution of the queries by communicating the queries and the results thereof over the network in batches.

The DB batch client 80 is a Java application residing on the client. The DB batch client 80 is operative to receive one or more SQL queries from the client application 70 in a batch. In the illustrated embodiment, the batch comprises a Java Vector. The DB batch client 80 is operatively connected to the DB batch servlet 64 to provide the batch of SQL queries to the servlet via the network.

The DB batch servlet 64 is a Java application residing on the server. The DB batch servlet 64 is operative to execute the SQL queries received from the DB batch client 80 to read data from and write data to the database 62 via the JDBC API 66. The DB batch servlet 64 is also operative to receive results from the query and provide the results to the DB batch client 80 via the network in a batch in the form of a Java Vector. The DB batch client 80 is further operative to provide the query results to the client application 70.

From the above description of the invention, those skilled in the art will perceive improvements, changes and modifications. Such improvements, changes and modifications within the skill of the art are intended to be covered by the appended claims.

Having described the invention, the following is claimed:

1. A computer product for generating application source code on a client computer for querying database tables on a server computer, said computer product comprising:
a portion for obtaining database structure information for the database tables from database table definition files on the server computer;
a portion operative to construct database queries using said database structure information, said database queries being constructed in a database query language required to query information from the database tables on the server computer; and
a portion for constructing application source code commands for executing said database queries, said application source code commands being constructed in a programming language of the client application.

2. The computer product recited in claim 1, wherein said database query language is Structured Query Language and said programming language of the client application is a Java language.

3. The computer product recited in claim 1, wherein said portion for constructing application source code commands comprises a portion for generating Java classes for executing Structured Query Language database queries.

4. The computer product recited in claim 3, wherein said Java classes comprise classes for encapsulating a single row of the database table.

5. The computer product recited in claim 3, wherein said Java classes comprise classes for encapsulating the entire database table.

6. The computer product recited in claim 1, wherein said portion for reading database table definition files is operative to access the database table definition files via a network connecting the client computer to the server computer.

7. The computer product recited in claim 1, further comprising a client-based portion for gathering a batch comprising a plurality of said application source code commands and sending said batch to the server computer; and
a server-based portion for receiving said batch from said client-based portion and executing said application source code commands of said batch on the database table.

8. The computer product recited in claim 7, wherein said server-based portion is further operative receive results of said database queries of said application source code commands and provide said results to said client-based portion, said client-based portion being further operative to receive said results.

9. The computer product recited in claim 8, wherein said client-based portion is further operative to provide said results to client-based applications on the client computer.

10. A computer implemented method for generating application source code on a client computer for querying database tables on a server computer, said method comprising the steps of:
obtaining database structure information for the database tables from database table definition files on the server computer;
constructing database queries using said database structure information, said database queries being constructed in a database query language required to query information from the database tables on the server computer; and
constructing application source code commands for executing said database queries, said application source code commands being constructed in a programming language of the client application.

11. The method recited in claim 10, wherein said database query language is Structured Query Language and said programming language of the client application is a Java language.

12. The method recited in claim 10, wherein said step of constructing application source code commands comprises the step of generating Java classes for executing Structured Query Language database queries.

13. The method recited in claim 12, wherein said Java classes comprise classes for encapsulating a single row of the database table.

14. The method recited in claim 12, wherein said Java classes comprise classes for encapsulating the entire database table.

15. The method recited in claim 10, wherein said step of reading database table definition files comprises the step of accessing the database table definition files via a network connecting the client computer to the server computer.

16. The method recited in claim 10, further comprising the steps of:
gathering a batch comprising a plurality of database queries;
sending said batch to the server computer;
receiving said batch from said client-based portion; and
executing said database queries of said batch on the database table.

17. The method recited in claim 16, further comprising the steps of:
receiving results of said database queries of said application source code commands on the server computer;
providing said results to the client computer; and
receiving said results on the client computer.

18. The method recited in claim 17, further comprising the step of providing said results to client-based applications on the client computer.

19. A computer product implementable on a system including a client computer and a server computer operatively connected to each other by a network, said computer product comprising comprising:
a client-based portion resident to the client computer, said client-based portion being operative to gather a batch comprising a plurality of database queries and send said batch to the server computer via the network; and
a server-based portion resident to the server computer, said server-based portion being operative to receive said batch from said client-based portion and execute said database queries in said batch on a database resident to the server computer.

20. The computer product recited in claim 19, wherein said server-based portion is further operative receive results of said database queries and provide said results to the client computer via the network, said client-based portion being further operative to receive said results and provide said results to client-based applications on the client computer.
